(19) United States
(12) Patent Application Publication
(10) Pub. No.: US 2016/0265133 A1
(43) Pub. Date: Sep. 15, 2016

(54) METHOD FOR MANUFACTURING AN AIRCRAFT COMPONENT EQUIPPED WITH A PROTECTION AGAINST ABRASION AND HEAT, AND AIRCRAFT COMPONENT MANUFACTURED THROUGH SAID METHOD

(71) Applicant: ALENIA AERMACCHI S.P.A., Roma (IT)

(72) Inventors: Luca BOTTERO, Olgiate Olona (VA) (IT); Massimo GREGORI, Tredate (VA) (IT)

(21) Appl. No.: 15/036,010

(22) PCT Filed: Nov. 10, 2014
(86) PCT No.: PCT/IB2014/065929

§ 371 Date: May 11, 2016

(30) Foreign Application Priority Data
Nov. 12, 2013 (IT) TO2013A000915

(51) Int. Cl. C25D 5/54; B64C 1/38; C25D 3/12; C25D 3/56; C25D 7/00; C25D 21/12

(52) U.S. Cl. CPC C25D 5/54; C25D 7/00; C25D 21/12; C25D 3/12; C25D 3/562; B64C 1/38; B64C 2001/0072

(57) ABSTRACT

A method includes providing an aircraft component including a substrate made of composite material and a polymeric matrix; and applying a protective coating made of metallic material to the substrate. The protective coating is applied to the polymeric matrix by an electrolytic deposition process.

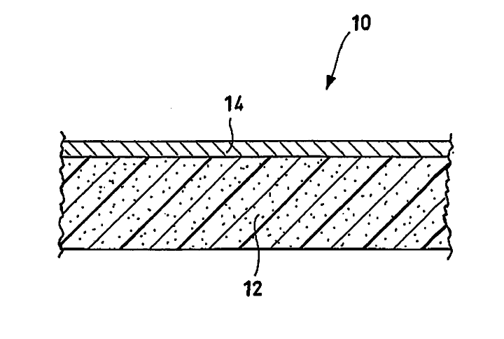

### TECHNICAL FIELD

The present invention relates to a method for manufacturing an aircraft component equipped with a protection against abrasion and heat, and to an aircraft component equipped with a protection against abrasion and heat, manufactured by using such method.

### BACKGROUND ART

More specifically, the present invention relates to a method and an aircraft component manufactured in accordance with the preamble of the appended independent claims.

In particular, the present invention relates to a method for manufacturing an aircraft component equipped with a protection against abrasion and heat, comprising the following operating steps:
providing an aircraft component comprising a substrate made of composite material and comprising a polymeric matrix; and
applying a protective coating made of metallic material to said substrate.

Furthermore, the present invention also relates, in particular, to an aircraft component equipped with a protection against abrasion and heat, comprising:
a substrate made of composite material and comprising a polymeric matrix, and
a protective coating made of metallic material applied to said substrate.

In aircraft components of the above-mentioned type, the protective coating typically has the function of preserving the composite material, which naturally tends to deteriorate when exposed to flight conditions on the aircraft. Some examples of such components are leading edges, noses, lips and load-bearing supports, such as masts for military aircrafts.

According to the prior art, the protective coating employed may consist of:
polymeric adhesive films, to be glued to the substrate of the aircraft component, or
protective paints, to be superimposed on said substrate by painting, or
thin metallic layers (or films) to be glued.

However, such devices suffer from a few drawbacks.

One drawback is that adhesive films, paints or thin metallic layers applied to the substrate have poor durability during the use of the component on the aircraft. This translates into a tendency towards removal of paints and primers in the exposed regions of the component. In recent advanced structures with high efficiency, which are made of composite material, this situation can cause adverse consequences on the substrate itself. In fact, the composite material may deteriorate, undergoing delamination and erosion by abrasion, leading to tear of superficial layers. In particular, when thin metallic layers are used, they are difficult to glue because of imperfections of the mating surfaces; also, the problems encountered during this glueing process translate into higher costs.

### SUMMARY OF THE INVENTION

It is one object of the present invention to provide a method and an aircraft component which can overcome this and other drawbacks of the prior art, while at the same time being simple and economical to manufacture.

According to the present invention, this and other objects are achieved through a method and an aircraft component of the type specified above, as defined in the characterizing part of the appended independent claims.

It is to be understood that the appended claims are an integral part of the technical teachings provided in the following detailed description of the invention. In particular, the appended dependent claims define some preferred embodiments of the present invention which include some optional technical features.

### BRIEF DESCRIPTION OF THE DRAWINGS

Further features and advantages of the present invention will become apparent from the following detailed description, which is merely supplied by way of non-limiting example, with particular reference to the annexed drawing, which shows a schematic representation of an aircraft component manufactured in accordance with one exemplary embodiment of the present invention.

### DETAILED DESCRIPTION OF THE INVENTION

With reference to the single figure provided, there is shown as a whole an aircraft component, designated 10, which is equipped with a protection against abrasion and heat, and which is manufactured in accordance with an exemplary embodiment of the present invention.

In one aspect, component 10 comprises a substrate 12 made of composite material and comprising a polymeric matrix. Component 10 also comprises a protective coating 14 made of metallic material, applied to substrate 12. Protective coating 14 is applied to the polymeric matrix of substrate 12 by means of an electrolytic deposition process, also referred to as “electroplating” or “galvanic deposition”.

In another aspect, the manufacturing method comprises the following operating steps:
providing an aircraft component 10 comprising a substrate 12 made of composite material and comprising a polymeric matrix; and
applying a protective coating 14 made of metallic material to substrate 12, wherein said coating 14 is applied to the polymeric matrix by means of an electrolytic deposition process.

Thanks to the above features, the developed solution can ensure a strong adhesion of the metallic material of the protective coating without affecting the properties of the substrate, particularly as concerns its polymeric matrix.

In the illustrated embodiment, the composite material of the substrate comprises a reinforcement made of fibrous material, e.g. carbon fibre. Preferably, the composite material is made, inclusive of said reinforcements of fibrous material, by injection moulding.

The polymeric material that contributes to forming substrate 12 may be of the thermoplastic or thermosetting type; in particular, its thickness may vary from a few hundredths of a millimetre to a few millimetres.

A further advantage is given by the fact that electrolytic deposition ensures effective control of the total thickness of the coating applied to the substrate, so that the overall weight of the aircraft component can be limited in accordance with the required specifications.

Aircraft component 10 may be any element to be installed on an aircraft, in particular any component that will stay exposed when the aircraft is in use. For example, component 10 may be a leading edge, a nose, a lip (i.e. the leading edge of an engine nacelle), or other components of the engine nacelle.

Most preferably, said aircraft component 10 may be at least one portion (e.g. the leading edge) of a wing of an aircraft or of a mast, for reasons that will be described in detail below.

Also preferably, said aircraft component 10 may be a portion (e.g. the external surface of the ventral part) of the fuselage.

Preferably, the electrolytic deposition process is carried out at a temperature which is lower than the boiling point of the electrolytic solution in use, in particular lower than approx. 100° C. In this manner, the polymeric matrix of substrate 12 will be allowed to bind to protective coating 14 without reaching temperatures that may affect the properties of said polymeric matrix.

Preferably, the metallic material applied to substrate 12 is resistant to abrasion. On the one hand, this counters abrasion due to impact with solid particles (fine dust) naturally present in the atmosphere, which is even more critical when the aircraft is flying in proximity to the ground or in dusty or sandy areas, also in the presence of sliding or friction. On the other hand, this also counters the effect that is caused by the so-called “plume” thermoabrasive abrasion, which occurs when aircraft component 10 is hit by a flare or jet coming from the engine of a missile or a rocket as it is ignited, until the latter goes off. The above-mentioned phenomenon is also known as “rocket plume”. Therefore, the aircraft component may advantageously be at least one portion, particularly the leading edge, of a wing of an aircraft or of a mast of an aircraft, in that these regions are typically those which are most affected by the “plume” abrasion problem.

In the illustrated embodiment, the metallic material employed for making protective coating 14 comprises nickel or alloys thereof.

Of course, without prejudice to the principle of the invention, the forms of embodiment and the implementation details may be extensively varied from those described and illustrated herein by way of non-limiting example, without however departing from the scope of the invention as set out in the appended claims.

As will be apparent to a man skilled in the art in the light of the above description, the use of an electrolytic deposition process for applying the protective coating to the substrate is advantageous over the current choice of a high-temperature treatment (e.g. carried out at temperatures higher than the boiling point of an electrolytic solution, i.e. approx. 100° C.). In fact, in the case of possible flamization (also defined as thermal-spray metallization), the temperature of the material applied as a protective coating would get close to the melting temperature of said material. This would imply a significant degradation of the properties of the substrate of composite material. Furthermore, in the case of flamization, the minimum attainable thickness of the protective coating would necessarily be greater than that which could be obtained by electrolytic deposition.

1. A method for manufacturing an aircraft component equipped with a protection against abrasion and heat, comprising the following operating steps:
providing an aircraft component comprising a substrate made of composite material and comprising a polymeric matrix; and
applying a protective coating made of metallic material to said substrate;
wherein said protective coating is applied to said polymeric matrix by an electrolytic deposition process
wherein said electrolytic deposition process is carried out at a temperature which is lower than a boiling point of the electrolytic solution.

2. The method according to claim 1, wherein said metallic material is resistant to abrasion.

3. The method according to claim 1, wherein said electrolytic deposition process is carried out at a temperature lower than approx. 100° C.

4. The method according to claim 1, wherein said metallic material is nickel or alloys thereof.

5. The method according to claim 1, wherein said composite material of the substrate comprises a reinforcement made of fibrous material, particularly carbon fibre.

6. An aircraft Aircraft component equipped with a protection against abrasion and heat, comprising:
a substrate made of composite material and comprising a polymeric matrix, and
a protective coating made of metallic material applied to said substrate;
wherein said protective coating is applied to said polymeric matrix by an electrolytic deposition process;
wherein said electrolytic deposition process is carried out at a temperature which is lower than a boiling point of the electrolytic solution.

7. The component according to claim 6, wherein said metallic material is resistant to abrasion.

8. The component according to claim 6, wherein said electrolytic deposition process is carried out at a temperature which is lower than approx. 100° C.

9. The component according to claim 6, wherein said metallic material is nickel or alloys thereof.

10. The component according to claim 6, wherein said composite material of the substrate comprises a reinforcement made of carbon fibre.

11. The component according to claim 6, wherein said composite material of the substrate comprises a reinforcement made of fibrous material.

12. The method according to claim 2, wherein said metallic material is resistant to thermoabrasive abrasion due to the “plume” effect.

13. The component according to claim 7, wherein said metallic material is resistant to thermoabrasive abrasion due to the “plume” effect.
